(19) United States
(12) Patent Application Publication
(10) Pub. No.: US 2025/0313154 A1
(43) Pub. Date: Oct. 9, 2025

(54) Utility Vehicle

(71) Applicant: Kubota Corporation, Osaka-shi (JP)

(72) Inventors: Masashi Inoue, Sakai-shi (JP); Yusuke Endo, Sakai-shi (JP)

(21) Appl. No.: 18/960,732

(22) Filed: Nov. 26, 2024

(30) Foreign Application Priority Data
Apr. 5, 2024 (JP) 2024-061331

(51) Int. Cl. B60R 5/02; B60J 5/02; E05C 3/00; E05C 3/04

(52) U.S. Cl. CPC B60R 5/02; B60J 5/02; E05C 3/004; E05C 3/042

(57) ABSTRACT

A utility vehicle includes a driving section on which an occupant rides, a hood changeable in position between a closed position where the hood blocks a storage space forward of the driving section and an open position where the storage space is exposed, and a locking section entirely made of an elastic material and capable of keeping the hood at the closed position.

### CROSS-REFERENCE TO RELATED APPLICATION

This application claims priority to Japanese Patent Application No. 2024-061331 filed Apr. 5, 2024, the disclosure of which is hereby incorporated by reference in its entirety.

### BACKGROUND OF THE INVENTION

### Field of the Invention

The present invention relates to a utility vehicle.

### Description of Related Art

For example, JP2001-260755A describes a utility vehicle (a “work vehicle” in the literature) including a locking section (a “hook” and an “engaging rod” in the literature) configured to keep a hood closed. Such a utility vehicle often travels on a so-called off-road such as a farm, a dangerous footing, a mountainous area, or a forest area, and the locking section easily receive large vibrations as compared with vehicles traveling on a pavement. It is also necessary to consider an impact resistance of the locking section. On this account, how the locking section can firmly keep the hood closed is a problem.

### SUMMARY OF THE INVENTION

The present invention provides a utility vehicle that can firmly fix a hood with a simple configuration. A utility vehicle of the present invention includes: a driving section on which an occupant rides; a hood changeable in position between a closed position where the hood blocks a storage space forward of the driving section and an open position where the storage space is exposed; and a locking section entirely made of an elastic material and capable of keeping the hood at the closed position.

In this configuration, the whole locking section is made of an elastic material, so that the hood is easily kept at the closed position by the elasticity of the locking section. Besides, since the whole locking section is made of an elastic material, the impact resistance of the whole locking section improves. Hereby, a utility vehicle that can firmly fix a hood with a simple configuration can be achieved.

In one preferred embodiment of the present invention, the hood may have a first hole through which the locking section passes, the utility vehicle may further include a support configured to support the hood and having a second hole allowing the locking section to pass through the second hole. The first hole may be inward of an edge portion of the second hole in a plan view while the hood is at the closed position. The locking section may be changeable between a retained state where the hood is kept at the closed position with the locking section being disposed through the first hole and the second hole and in contact with a back surface portion of the support, the back surface portion being opposite from a front surface portion of the support which front surface portion faces the hood, and a released state where the locking section does not abut with the back surface portion and allows the hood to change to the open position.

In this configuration, when the locking section passes through the first hole and the second hole to abut with the back surface portion, the hood can be kept at the closed position. Since the first hole is inward of the edge portion of the second hole in a plan view while the hood is at the closed position, a configuration where the locking section is locked only on the hood but not locked on the support can be easily achieved. Hereby, the locking section is changeable between the retained state and the released state with a simple configuration.

In one preferred embodiment of the present invention, the utility vehicle of the present invention may further include a fitting body provided for a lower portion of the locking section and having a longitudinal dimension larger than a lateral dimension of the second hole but smaller than a longitudinal dimension of the second hole. The second hole may be an elongated hole. The fitting body may extend along a lateral direction of the second hole while the locking section is in the retained state, and the fitting body may extend along a longitudinal direction of the second hole while the locking section is in the released state.

In this configuration, when the long side of the fitting body which long side is longer in length than the short side of the second hole extends along the short direction of the second hole, the retained state of the locking section is achieved. In the meantime, when the long side of the fitting body which long side is shorter in length than the long side of the second hole extends along the longitudinal direction of the second hole, the released state of the locking section is achieved.

In one preferred embodiment of the present invention, the support may include at least one protrusion adjacent to a longitudinally central portion of the second hole and protruding toward an opposite side from the front surface portion, and the fitting body may include a contact section configured to come into contact with the at least one protrusion.

In this configuration, a protrusion is provided for a portion of the support which portion is adjacent to the second hole, and the contact section abuts with the protrusion. Accordingly, in comparison with a configuration in which no protrusion is provided, the contact section firmly abuts with the back surface portion, and the locking section is firmly kept in the retained state.

In one preferred embodiment of the present invention, the contact section may have a triangular shape tapered upward as viewed along a longitudinal direction of the fitting body, the at least one protrusion may include two triangular portions projecting toward the opposite side from the front surface portion, and the contact section may be between the two triangular portions while the locking section is in the retained state, and the contact section may not be between the two triangular portions while the locking section is in the released state.

In this configuration, since the contact section is between the two triangular portions, it is necessary for the contact section to climb over either of the two triangular portions at the time when the locking section is changed from the retained state to the released state. Accordingly, it is possible to reduce such a risk that the contact section unintentionally comes off the protrusion, and the locking section is more firmly kept in the retained state.

In one preferred embodiment of the present invention, the at least one protrusion may include two protrusions arranged along the lateral direction of the second hole and adjacent to a right portion of the second hole and a left portion of the second hole and the two triangular portions may be provided for at least one of the two protrusions.

With this configuration, the locking section is more firmly kept in the retained state.

The above-mentioned and other embodiments, procedures, features, and effects of the present invention will be more apparent from the following detailed description of the embodiments with reference to the drawings.

### BRIEF DESCRIPTION OF THE DRAWINGS

FIG. 1 is a general side view of a utility vehicle.

FIG. 2 is a plan view illustrating a hood.

FIG. 3 is a side view of a locking section.

FIG. 4 is a side view of the locking section as viewed in a right-left direction relative to a viewpoint illustrated in FIG. 3.

FIG. 5 is a sectional view along a line V-V in FIG. 3 to illustrate the locking section in a plan view.

FIG. 6 is a bottom plan view illustrating the locking section in a retained state.

FIG. 7 is a bottom plan view illustrating the locking section in a released state.

FIG. 8 is a side sectional view illustrating the locking section in the retained state.

FIG. 9 is a side sectional view illustrating the locking section in the retained state.

FIG. 10 is a side sectional view illustrating the locking section in the released state.

### DESCRIPTION OF THE INVENTION

An embodiment to carry out the present invention will be described with reference to the drawings. In the following description, a direction of an arrow “F” in the drawings indicates “forward,” a direction of an arrow “B” indicates “rearward,” a direction of an arrow “L” indicates “left,” and a direction of an arrow R indicates “right,” unless otherwise specified. Further, in the drawings, a direction of an arrow “U” indicates “upward,” and a direction of an arrow “D” indicates “downward.”

### [Overall Configuration of Multipurpose Vehicle]

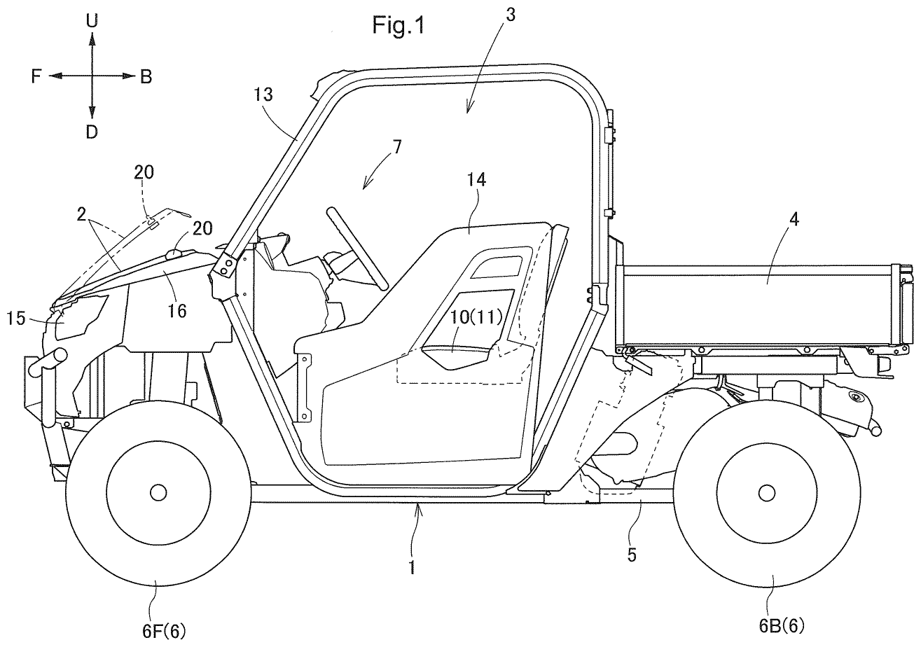

The following describes a utility vehicle of the present embodiment. As illustrated in FIG. 1, the utility vehicle includes a traveling body 1, a hood 2, a driving section 3 on which an occupant rides, and a dump-type cargo box 4. The traveling body 1 includes a body frame 5 and a travel device 6. Although not illustrated herein, the utility vehicle includes a water-cooling engine and a transmission, and power of the engine is shifted by the transmission and transmitted to the travel device 6. Note that the utility vehicle may be an electrically-driven utility vehicle including an electric motor for traveling.

The travel device 6 includes right and left front wheels 6F that are steerable and drivable, and right and left rear wheels 6B that are unsteerable and drivable. The travel device 6 can switch its driving state between a two-wheel drive state where only the right and left rear wheels 6B are driven and a four-wheel drive state where the right and left front wheels 6F and the right and left rear wheels 6B are driven.

The driving section 3 includes an operation section 7, a driver seat 10, an auxiliary seat 11, a ROPS 13 for protecting an occupant, and right and left entrance doors 14. The cargo box 4 is rearward of the driving section 3. The entrance door 14 opens and closes a doorway of the driving section 3.

The operation section 7 includes various operation tools such as a steering wheel configured to steer the right and left front wheels 6F, an accelerator pedal configured to adjust a traveling speed, a brake pedal configured to perform braking, and a shift lever configured to perform shifting.

An occupant who drives the utility vehicle sits on the driver seat 10. The auxiliary seat 11 is laterally adjacent to the driver seat 10. The driver seat 10 is provided on the left side of the traveling body 1 in the right-left direction, and the auxiliary seat 11 is provided on the right side of the traveling body 1 in the right-left direction.

### [Configuration of Bonnet]

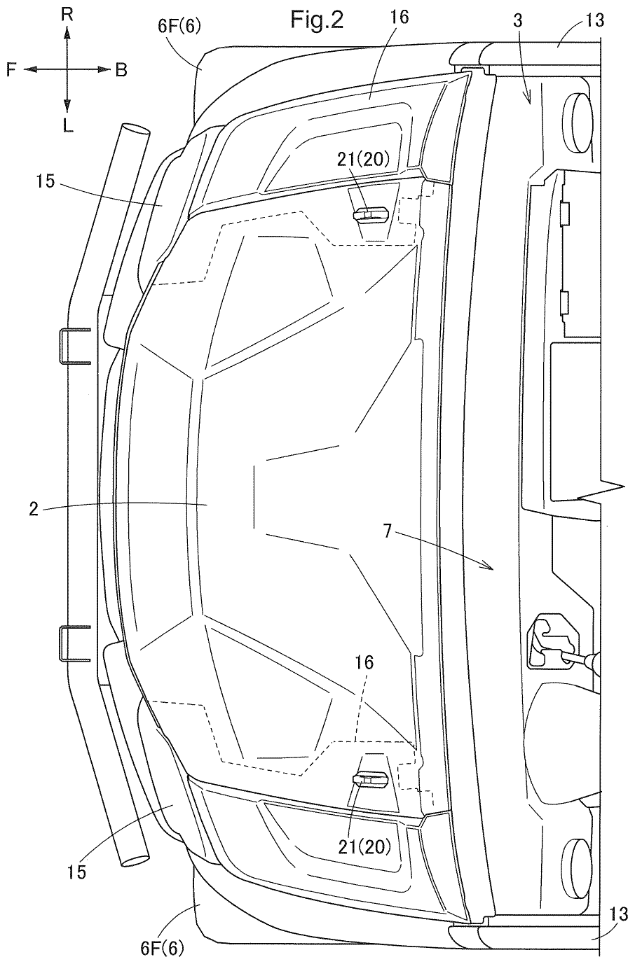

As illustrated in FIGS. 1, 2, the hood 2 is forward of the driving section 3. Although not described in detail, auxiliary machines such as a radiator, a steering mechanism and a suspension mechanism for the right and left front wheels 6F, harnesses of headlights 15, and so on are stored under the hood 2. Note that a space under the hood 2 may be configured as a front trunk. Right and left side cowls 16 are provided on both lateral sides of the hood 2. The right and left side cowls 16 are supports for supporting the hood 2. Respective headlights 15 are attached to the right and left side cowls 16. The side cowl 16 has a front surface portion 16F facing the hood 2, and a back surface portion 16B opposite from the front surface portion 16F.

As illustrated in FIG. 1, a front end portion of the hood 2 is supported by the right and left side cowls 16 in such a manner as to be swingable. Hereby, the hood 2 is vertically swingable around an axis of the front end portion which axis extends in a body width direction. When the hood 2 swings upward, the hood 2 opens. The hood 2 is swingable between a closed position where the hood 2 is closest to the whole front surface portion 16F of the side cowl 16 in the front-rear direction and an open position where the hood 2 swings upward relative to the closed position. In other words, the hood 2 is changeable in position between the closed position where the hood 2 blocks a storage space forward of the driving section 3 and the open position where the storage space is released. For example, an operator or the like can perform maintenance on a device disposed under the hood 2 while the hood 2 is at the open position.

The hood 2 and the side cowl 16 are made of resin such as polyvinyl chloride or fiber reinforced plastics (FRP), for example.

In the present embodiment, respective locking sections 20 are attached to a right portion and a left portion of a rear portion of the hood 2. The right portion and the left portion of the rear portion of the hood 2 each have a first hole 2h, and an insertion section 23 of the locking section 20 passes through the first hole 2h. The first hole 2h is an elongated hole. The whole locking section 20 is made of an elastic material such as rubber. The whole locking section 20 is an integrated object.

The locking section 20 can keep the hood 2 at the closed position. When the operator rotates the locking section 20 around an axis extending in an up-down direction, the locking section 20 is changeable between a retained state where the hood 2 is kept at the closed position and a released state where the hood 2 is allowed to swing to the open position.

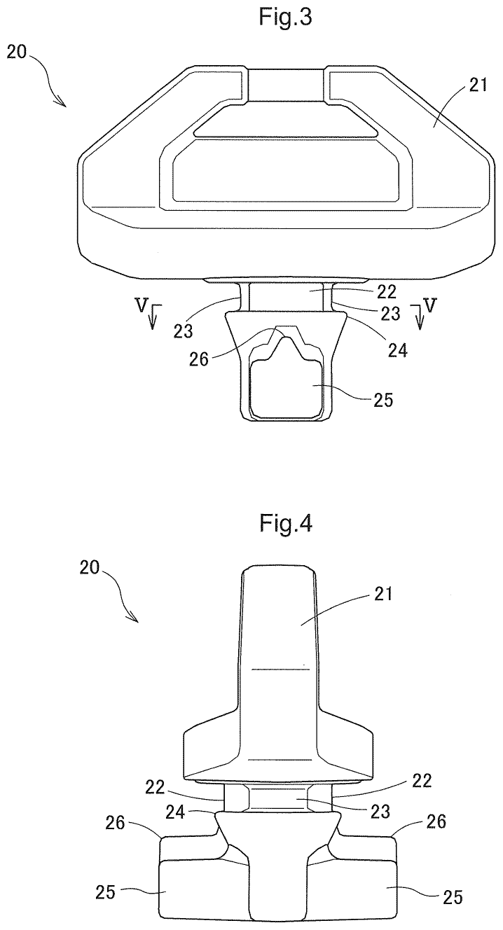

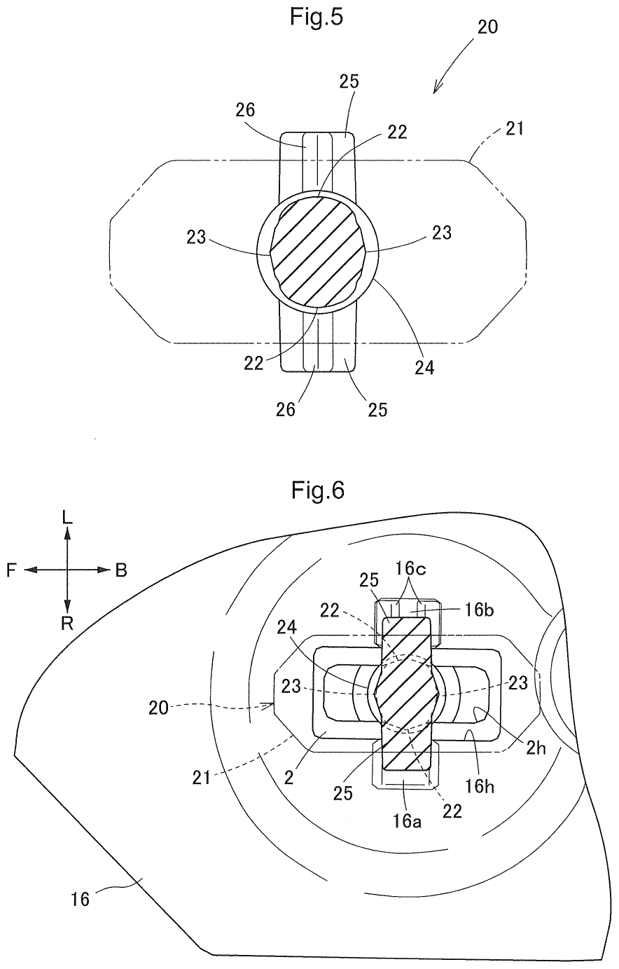

As illustrated in FIGS. 3 to 5, the locking section 20 includes an operating section 21, the insertion section 23, a snap fit 24, and a fitting body 25. The operating section 21 is a portion of the locking section 20 which portion is manually operated by the operator or the like in such a manner to swing.

The insertion section 23 of the locking section 20 is a portion passing through the first hole 2h. The insertion section 23 includes a protrusion engagement section 22. The protrusion engagement section 22 is a portion formed wide in the insertion section 23 and is wider in width than the width of the first hole 2h in its short direction.

The snap fit 24 has a diameter larger than the width of the first hole 2h in the short direction. The snap fit 24 is downward of the first hole 2h.

The diameter of the snap fit 24 is increased toward the upper side. Accordingly, when the locking section 20 is inserted into the first hole 2h in an assembling process, the snap fit 24 passes through the first hole 2h while elastically deforming. When the whole snap fit 24 is displaced downward from the first hole 2h, the shape of the snap fit 24 is restored to its original state due to elasticity and locked on a bottom surface portion of the hood 2.

The protrusion engagement section 22 and the insertion section 23 are between the operating section 21 and the snap fit 24 and have respective diameters thinner than those of the operating section 21 and the snap fit 24. Accordingly, even in a case where the locking section 20 is pulled upward, the snap fit 24 abuts with the hood 2 from the lower side, so that the locking section 20 is maintained not to fall out from the first hole 2h.

The fitting body 25 is under the snap fit 24 and extends in the right-left direction. The length of the fitting body 25 in its longitudinal direction is shorter than the length of the first hole 2h in its longitudinal direction. Accordingly, in the assembling process, the locking section 20 is inserted into the first hole 2h without the fitting body 25 being caught on the first hole 2h.

The locking section 20 includes two abutment sections 26 upward of a right portion and a left portion of the fitting body 25 across the insertion section 23 and the snap fit 24. The two abutment sections 26 have a bell shape (a triangular shape) reduced in width toward the upper side as viewed along the longitudinal direction of the fitting body 25. The two abutment sections 26 can abut with the back surface portion 16B of the side cowl 16.

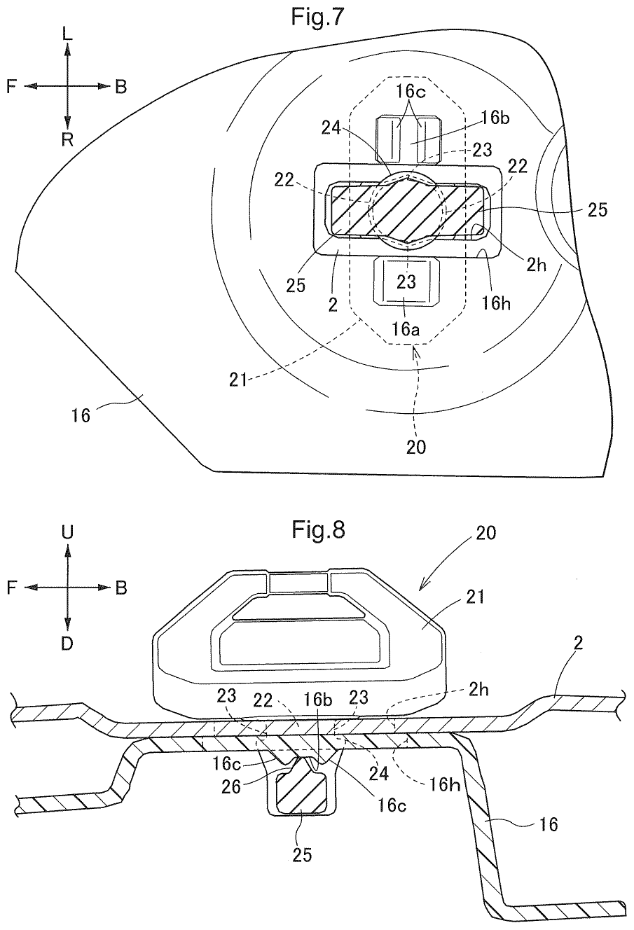

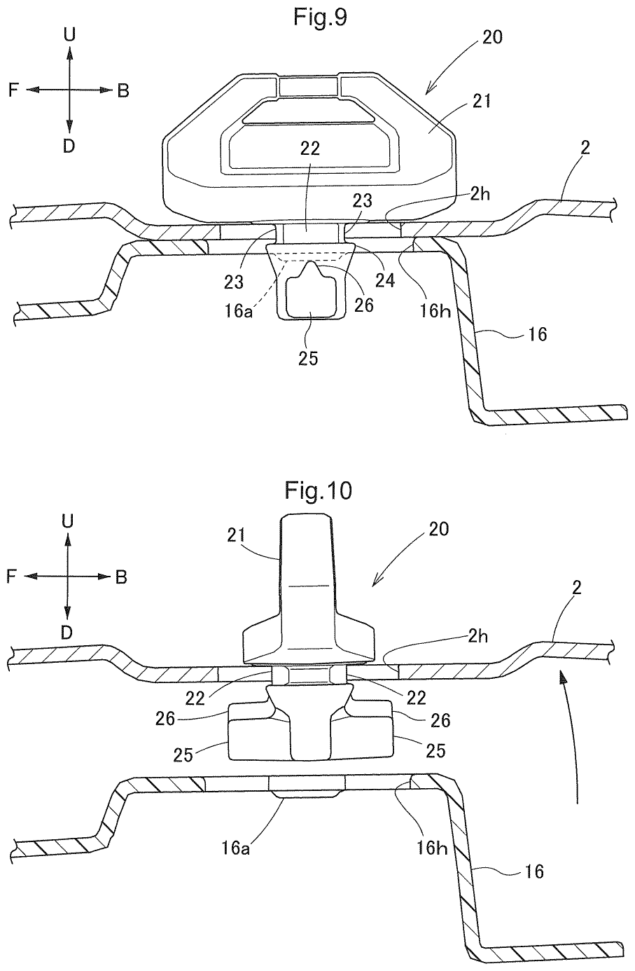

As illustrated in FIGS. 6 to 9, respective rear portions of the right and left side cowls 16 have respective second holes 16h. The second hole 16h is an elongated hole. While the hood 2 is at the closed position, the first hole 2h is inward of an edge portion of the second hole 16h in a plan view. In other words, while the hood 2 is at the closed position, the region of the first hole 2h and the region of the second hole 16h overlap with each other in a plan view. The longitudinal direction of the first hole 2h and the longitudinal direction of the second hole 16h are along the same direction or generally along the same direction.

The width of the second hole 16h in its short direction is wider than the diameter of the snap fit 24. Accordingly, the whole snap fit 24 can pass through the second hole 16h without the snap fit 24 being caught on the back surface portion 16B outward of the second hole 16h.

The fitting body 25 has a long side longer in length than a short side of the second hole 16h but shorter than a long side of the second hole 16h. The locking section 20 is rotatable around an axis extending in the up-down direction. While the locking section 20 is in the retained state, the fitting body 25 extends along the short direction of the second hole 16h, and while the locking section 20 is in the released state, the fitting body 25 extends along the longitudinal direction of the second hole 16h. Accordingly, when the locking section 20 is in the retained state, the fitting body 25 is caught on the back surface portion 16B outward of the edge portion of the second hole 16h, so that the fitting body 25 does not come off the second hole 16h. Hereby, the position of the hood 2 is kept at the closed position.

While the locking section 20 is in the released state, the fitting body 25 is inward of the edge portion of the second hole 16h. Accordingly, when the hood 2 swings upward (toward the open position), the fitting body 25 comes out of the second hole 16h without being caught on the back surface portion 16B, as illustrated in FIG. 10.

Thus, the locking section 20 is changeable between the retained state where the hood 2 is kept at the closed position with the fitting body 25 being inserted into the first hole 2h and the second hole 16h and abutting with the back surface portion 16B of the side cowl 16 and the released state where the fitting body 25 does not abut with the back surface portion 16B and the hood 2 is allowed to change to the open position.

As illustrated in FIGS. 6 to 9, in the present embodiment, two protrusions 16a, 16b are formed on the back surface portion 16B. The protrusions 16a, 16b are adjacent to a right portion and a left portion of a center portion of the second hole 16h in its longitudinal direction. The protrusions 16a, 16b protrude to a direction reverse to the front surface portion 16F. While the locking section 20 is the retained state, the two abutment sections 26 abut with the protrusions 16a, 16b. At this time, respective upper end portions of the two abutment sections 26 elastically deform due to abutment with the protrusions 16a, 16b.

In the present embodiment, the protrusion 16b includes two triangular portions 16c. The two triangular portions 16c project further toward the direction reverse to the front surface portion 16F from a flat surface portion of the protrusion 16b.

When the locking section 20 is changed from the released state to the retained state, the whole locking section 20 rotates around the axis extending in the up-down direction along respective center portions of the insertion section 23 and the snap fit 24, and either one of the right and left abutment sections 26 abuts with one of the triangular portions 16c from a side not facing the other one of the triangular portions 16c. When the whole locking section 20 is further rotated in the same direction, the upper end portion of the one of the right and left abutment sections 26 elastically deforms and climbs over the one of the triangular portions 16c. Then, while the shape of the one of the right and left abutment sections 26 is restored to the original state due to elasticity, the one of the right and left abutment sections 26 abuts with the flat surface portion of the protrusion 16b between the two triangular portions 16c. The other one of the right and left abutment sections 26 abuts with a flat surface portion of the protrusion 16a.

While the locking section 20 is in the retained state, the protrusion engagement section 22 of the insertion section 23 is pressed against both edge portions of the first hole 2h in the short direction, so that a frictional force acts between the protrusion engagement section 22 and the first hole 2h. Hereby, the locking section 20 can hardly rotate, thereby reducing such a risk that the locking section 20 rotates suddenly due to vibrations or the like.

While the locking section 20 is the retained state, the one of the right and left abutment sections 26 is between the two triangular portions 16c. Accordingly, in order that the one of the right and left abutment sections 26 comes out from between the two triangular portions 16c, it is necessary that the one of the right and left abutment sections 26 elastically deform and climb over one of the triangular portions 16c. In addition, the right and left abutment sections 26 abut with the protrusions 16a, 16b and receive frictional forces, so that the locking section 20 can hardly rotate. Accordingly, it is possible to avoid such a risk that the locking section 20 is unintentionally changed from the retained state to the released state due to vibrations of the vehicle or the like.

At the time when the locking section 20 is changed from the retained state to the released state, the whole locking section 20 rotates around the axis extending in the up-down direction along respective center portions of the insertion section 23 and the snap fit 24, so that the one of the right and left abutment sections 26 between the two triangular portions 16c abuts with one of the two triangular portions 16c. When the whole locking section 20 is further rotated in the same direction, the upper end portion of the one of the right and left abutment sections 26 elastically deforms and climbs over the one of the two triangular portions 16c. Then, while the shape of the one of the right and left abutment sections 26 is restored to the original state due to elasticity, the whole fitting body 25, including the abutment sections 26, is placed inward of the edge portion of the second hole 16h. Hereby, the locking section 20 is changed from the retained state to the released state, so that the hood 2 is swingable from the closed position to the open position.

Thus, while the locking section 20 is the retained state, the abutment section 26 is between the two triangular portions 16c, but while the locking section 20 is the released state, the abutment section 26 is not between the two triangular portions 16c.

In the meantime, the protrusion 16a is provided with no triangular portion 16c, and the protrusion 16b is provided with the two triangular portions 16c. With this configuration, in comparison with a configuration where the protrusion 16a is provided with two triangular portions 16c, and the protrusion 16b is provided with two triangular portions 16c, only one of the two abutment sections 26 climes over the triangular portion 16c, so that the operator can easily rotate the locking section 20 without excessive physical strength.

### Alternative Embodiments

The present invention is not limited to the configuration described in the above embodiment, and the following describes alternative embodiments of the present invention.
(1) In the above embodiment, the protrusion 16a is not provided with two triangular portions 16c, and the protrusion 16b is provided with two triangular portions 16c. The present invention is not limited to this embodiment. The protrusion 16a may be provided with two triangular portions 16c, and the protrusion 16b may be provided with two triangular portions 16c. That is, at least one of the two protrusions 16a, 16b may be provided with two triangular portions 16c.
(2) The protrusions 16a, 16b may not be necessarily provided in the central portion of the second hole 16h in the right-left direction and may be provided in either one end portion of the second hole 16h or the other end portion thereof.
(3) In the above embodiment, the front end portion of the hood 2 is supported by the right and left side cowls 16 in such a manner as to be swingable. Hereby, the hood 2 is vertically swingable around the axis of the front end portion which axis extends in the body width direction. The present invention is not limited to this embodiment, and a rear end portion of the hood 2 may be supported by the right and left side cowls 16 in such a manner as to be swingable. Hereby, the hood 2 may be vertically swingable around an axis of the rear end portion which axis extends in the body width direction. Alternatively, the hood 2 may be configured to slide back and forth or right and left.
(4) In the above embodiment, the locking section 20 is provided as an integrated object. The present invention is not limited to this embodiment, and the locking section 20 may be constituted by a plurality of elastic materials.
(5) In the above embodiment, two locking sections 20 are separately provided for right and left end portions of the hood 2. The present invention is not limited to this embodiment. Only one locking section 20 may be provided, or three or more locking sections 20 may be provided.

The features of the embodiments described above (including other embodiments, which also apply hereinafter) may be combined with a feature disclosed in another embodiment, provided that such a combination does not result in a contradiction. The embodiments described in the present specification are illustrative and should not be construed as limiting the present invention. Modifications to the present invention are permissible, as long as they do not deviate from the scope that can achieve the objects of the present invention.

The present invention is applicable to a utility vehicle.

What is claimed is:

1. A utility vehicle, comprising:
a driving section on which an occupant rides;
a hood changeable in position between a closed position where the hood blocks a storage space forward of the driving section and an open position where the storage space is exposed; and
a locking section entirely made of an elastic material and capable of keeping the hood at the closed position.

2. The utility vehicle according to claim 1, wherein:
the hood has a first hole through which the locking section passes,
the utility vehicle further comprises a support configured to support the hood and having a second hole allowing the locking section to pass through the second hole,
the first hole is inward of an edge portion of the second hole in a plan view while the hood is at the closed position, and
the locking section is changeable between a retained state where the hood is kept at the closed position with the locking section being disposed through the first hole and the second hole and in contact with a back surface portion of the support, and the back surface portion being opposite from a front surface portion of the support which front surface portion faces the hood, and a released state where the locking section does not abut with the back surface portion and allows the hood to change to the open position.

3. The utility vehicle according to claim 2, further comprising:
a fitting body provided for a lower portion of the locking section and having a longitudinal dimension larger than a lateral dimension of the second hole but smaller than a longitudinal dimension of the second hole,
wherein the second hole is an elongated hole, and
wherein the fitting body extends along a lateral direction of the second hole while the locking section is in the retained state, and the fitting body extends along a longitudinal direction of the second hole while the locking section is in the released state.

4. The utility vehicle according to claim 3, wherein:
the support comprises at least one protrusion adjacent to a longitudinally central portion of the second hole and protruding toward an opposite side from the front surface portion, and
the fitting body comprises a contact section configured to come into contact with the at least one protrusion.

5. The utility vehicle according to claim 4, wherein:
the contact section has a triangular shape tapered upward as viewed along a longitudinal direction of the fitting body,
the at least one protrusion comprises two triangular portions projecting toward the opposite side from the front surface portion, and
the contact section is between the two triangular portions while the locking section is in the retained state, and the contact section is not between the two triangular portions while the locking section is in the released state.

6. The utility vehicle according to claim 5, wherein:
the at least one protrusion comprises two protrusions arranged along the lateral direction of the second hole and adjacent to a right portion of the second hole and a left portion of the second hole, and
the two triangular portions are provided for at least one of the two protrusions.
